(19) United States
(12) Patent Application Publication
(10) Pub. No.: US 2005/0129274 A1
(43) Pub. Date: Jun. 16, 2005

(54) Motion-based segmentor detecting vehicle occupants using optical flow method to remove effects of illumination

(76) Inventors: Michael E. Farmer, Bloomfield, MI (US); Li Wen, Rochester, MI (US)

Correspondence Address: Martin J. Jaquez, Esq.;JAQUEZ & ASSOCIATES, Suite 100D, 6265 Greenwich Drive, San Diego, CA, 92122, US

(21) Appl. No.: 10/944,482

(22) Filed: Sep. 16, 2004

Related U.S. Application Data
(63) Continuation-in-part of application No. 10/269,237, filed on Oct. 11, 2002.
(63) Continuation-in-part of application No. 10/269,357, filed on Oct. 11, 2002.
(63) Continuation-in-part of application No. 10/023,787, filed on Dec. 17, 2001.
(63) Continuation-in-part of application No. 09/901,805, filed on Jul. 10, 2001.
(63) Continuation-in-part of application No. 10/023,787, filed on Dec. 17, 2001.
(63) Continuation-in-part of application No. 09/901,805, filed on Jul. 10, 2001.
(63) Continuation-in-part of application No. 09/870,151, filed on May 30, 2001, now Pat. No. 6,459,974.
(63) Continuation-in-part of application No. 10/006,564, filed on Nov. 5, 2001, now Pat. No. 6,577,936.
(63) Continuation-in-part of application No. 10/052,152, filed on Jan. 17, 2002, now Pat. No. 6,662,093.
Application No. 10/269,357 is a continuation-in-part of application No. 10/023,787, filed on Dec. 17, 2001.
Application No. 10/269,357 is a continuation-in-part of application No. 09/901,805, filed on Jul. 10, 2001.
Application No. 10/269,357 is a continuation-in-part of application No. 09/870,151, filed on May 30, 2001, now Pat. No. 6,459,974.
Application No. 10/269,357 is a continuation-in-part of application No. 10/006,564, filed on Nov. 5, 2001, now Pat. No. 6,577,936.
Application No. 10/269,357 is a continuation-in-part of application No. 10/052,152, filed on Jan. 17, 2002, now Pat. No. 6,662,093.
Application No. 10/023,787 is a continuation-in-part of application No. 09/870,151, filed on May 30, 2001, now Pat. No. 6,459,974.
Application No. 10/023,787 is a continuation-in-part of application No. 09/901,805, filed on Jul. 10, 2001.
Application No. 10/023,787 is a continuation-in-part of application No. 10/006,564, filed on Nov. 5, 2001, now Pat. No. 6,577,936.
Application No. 10/006,564 is a continuation-in-part of application No. 09/901,805, filed on Jul. 10, 2001.
Application No. 10/052,152 is a continuation-in-part of application No. 09/870,151, filed on May 30, 2001, now Pat. No. 6,459,974.
Application No. 10/052,152 is a continuation-in-part of application No. 10/006,564, filed on Nov. 5, 2001, now Pat. No. 6,577,936.
Application No. 10/052,152 is a continuation-in-part of application No. 09/901,805, filed on Jul. 10, 2001.
Application No. 10/052,152 is a continuation-in-part of application No. 10/023,787, filed on Dec. 17, 2001.

(51) Int. Cl. G06K 9/00

(52) U.S. Cl. 382/103

(57) ABSTRACT

An image segmentation method and apparatus are described. The inventive system and apparatus generates a segmented image of an occupant or other target of interest based upon an ambient image, which includes the target and the environment in the vehicle that surrounds the target. The inventive concept defines a bounding ellipse for the target. This ellipse may be provided to a processing system that performs tracking of the target. In one embodiment, an optical flow technique is used to compute motion and illumination field values. The explicit computation of the effects of illumination dramatically improves motion estimation and thereby facilitates computation of the bounding ellipses.

### CROSS REFERENCE TO RELATED APPLICATIONS—CLAIM OF PRIORITY

This application is a Continuation-in-Part (CIP) and claims the benefit under 35 USC § 120 to the following U.S. applications: “MOTION-BASED IMAGE SEGMENTOR FOR OCCUPANT TRACKING,” application Ser. No. 10/269,237, filed Oct. 11, 2002, pending; “MOTION BASED IMAGE SEGMENTOR FOR OCCUPANT TRACKING USING A HAUSDORF DISTANCE HEURISTIC,” application Ser. No. 10/269,357, filed Oct. 11, 2002, pending; “IMAGE SEGMENTATION SYSTEM AND METHOD,” application Ser. No. 10/023,787, filed Dec. 17, 2001, pending; and “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” application Ser. No. 09/901,805, filed Jul. 10, 2001, pending.

Both the application Ser. Nos. 10/269,237 and 10/269,357 patent applications are themselves Continuation-in-Part applications of the following U.S. patent applications: “IMAGE SEGMENTATION SYSTEM AND METHOD,” application Ser. No. 10/023,787, filed on Dec. 17, 2001, pending; “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” application Ser. No. 09/901,805, filed on Jul. 10, 2001, pending; “A RULES-BASED OCCUPANT CLASSIFICATION SYSTEM FOR AIRBAG DEPLOYMENT,” application Ser. No. 09/870,151, filed on May 30, 2001, which issued as U.S. Pat. No. 6,459,974 on Oct. 1, 2002; “IMAGE PROCESSING SYSTEM FOR ESTIMATING THE ENERGY TRANSFER OF AN OCCUPANT INTO AN AIRBAG,” application Ser. No. 10/006,564, filed on Nov. 5, 2001, which issued as U.S. Pat. No. 6,577,936 on Jun. 10, 2003; and “IMAGE PROCESSING SYSTEM FOR DETECTING WHEN AN AIRBAG SHOULD BE DEPLOYED,” application Ser. No. 10/052,152, filed on Jan. 17, 2002, which issued as U.S. Pat. No. 6,662,093 on Dec. 9, 2003. U.S. application Ser. No. 10/023,787 cited above is a CIP of the following applications: “A RULES-BASED OCCUPANT CLASSIFICATION SYSTEM FOR AIRBAG DEPLOYMENT,” application Ser. No. 09/870,151, filed May 30, 2001, which issued on Oct. 1, 2002 as U.S. Pat. No. 6,459,974; “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” application Ser. No. 09/901,805, filed Jul. 10, 2001, pending; and “IMAGE PROCESSING SYSTEM FOR ESTIMATING THE ENERGY TRANSFER OF AN OCCUPANT INTO AN AIRBAG” application Ser. No. 10/006,564, filed November 5, 2001, which issued June 10, 2003 as U.S. Pat. No. 6,577,936.

U.S. Pat. No. 6,577,936, cited above, is itself a CIP of “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” application Ser. No. 09/901,805, filed on Jul. 10, 2001, pending. U.S. Pat. No. 6,662,093, cited above, is itself a CIP of the following U.S. patent applications: “A RULES-BASED OCCUPANT CLASSIFICATION SYSTEM FOR AIRBAG DEPLOYMENT,” application Ser. No. 09/870,151, filed on May 30, 2001, which issued as U.S. Pat. No. 6,459,974 on Oct. 1, 2002; “IMAGE PROCESSING SYSTEM FOR ESTIMATING THE ENERGY TRANSFER OF AN OCCUPANT INTO AN AIRBAG,” application Ser. No. 10/006,564, filed on Nov. 5, 2001, which issued as U.S. Pat. No. 6,577,936 on 6-10-2003; “IMAGE PROCESSING SYSTEM FOR DYNAMIC SUPPRESSION OF AIRBAGS USING MULTIPLE MODEL LIKELIHOODS TO INFER THREE DIMENSIONAL INFORMATION,” application Ser. No. 09/901,805, filed on Jul. 10, 2001, pending; and “IMAGE SEGMENTATION SYSTEM AND METHOD,” application Ser. No. 10/023,787, filed on Dec. 17, 2001, pending.

All of the above-cited pending patent applications and issued patents are commonly owned by the assignee hereof, and are all fully incorporated by reference herein, as though set forth in full, for their teachings on identifying segmented images of a vehicle occupant within an ambient image.

### BACKGROUND

1. Field

The present invention relates in general to systems and techniques used to isolate a “segmented image” of a moving person or object, from an “ambient image” of the area 5 surrounding and including the person or object in motion. In particular, the present invention relates to a method and apparatus for isolating a segmented image of a vehicle occupant from the ambient image of the area surrounding and including the occupant, so that an appropriate airbag deployment decision can be made.

2. Description of Related Art

There are many situations in which it may be desirable to isolate a segmented image of a “target” person or object from an ambient image which includes the image surrounding the “target” person or object. Airbag deployment systems are one prominent example of such a situation. Airbag deployment systems can make various deployment decisions that relate to the characteristics of an occupant that can be obtained from the segmented image of the occupant. The type of occupant, the proximity of an occupant to the airbag, the velocity and acceleration of an occupant, the mass of the occupant, the amount of energy an airbag needs to absorb as a result of an impact between the airbag and the occupant, and other occupant characteristics are all factors that can be incorporated into airbag deployment decision-making.

There are significant obstacles in the existing art with respect to image segmentation techniques. Prior art image segmentation techniques tend to be inadequate in high-speed target environments, such as when attempting to identify a segmented image of an occupant in a vehicle that is braking or crashing. Prior art image segmentation techniques do not account for nor use motion of an occupant to assist in the identification of the boundary between the occupant and the area surrounding the environment. Instead of using the motion of the occupant to assist with image segmentation, prior art systems typically apply techniques best suited for low-motion or even static environments, “fighting” the motion of the occupant instead of utilizing characteristics relating to the motion to assist in the segmentation and identification process.

Related to the difficulties imposed by occupant motion is the challenge of timeliness. A standard video camera typically captures about 40 frames of images each second. Many airbag deployment embodiments incorporate sensors that capture sensor readings at an even faster rate than a standard video camera. Airbag deployment systems require reliable real-time information for deployment decisions. The rapid capture of images or other sensor data does not assist the airbag deployment system if the segmented image of the occupant cannot be identified before the next frame or sensor measurement is captured. An airbag deployment system can only be as fast as its slowest requisite process step. However, an image segmentation technique that uses the motion of the vehicle occupant in the segmentation process can perform its task more rapidly than a technique that fails to utilize motion as a distinguishing factor between an occupant and the area surrounding the occupant.

Prior art systems typically fail to incorporate contextual “intelligence” about a particular situation into the segmentation process, and thus such systems do not focus on any particular area of the ambient image. A segmentation process specifically designed for airbag deployment processing can incorporate contextual “intelligence” that cannot be applied by a general purpose image segmentation process. For example, it is desirable for a system to focus on an area of interest within the ambient image using recent past segmented image information, including past predictions that incorporate subsequent anticipated motion. Given the rapid capture of sensor measurements, there is a limit to the potential movement of the occupant between sensor measurements. Such a limit is context specific, and is closely related to factors such as the time period between sensor measurements.

Prior art segmentation techniques also fail to incorporate useful assumptions about occupant movement in a vehicle. It is desirable for a segmentation process for use in a vehicle to take into consideration the observation that vehicle occupants tend to rotate about their hips, with minimal motion in the seat region. Such “intelligence” can allow a system to focus on the most important areas of the ambient image, saving valuable processing time.

Further aggravating processing time demands in existing segmentation systems is the failure of those systems to incorporate past data into present determinations. It is desirable to track and predict occupant characteristics using techniques such as “Kalman” filters. It is also desirable to model the segmented image by a simple geometric shape, such as an ellipse. The use of a reusable and modifiable shape model can be a useful way to incorporate past data into present determinations, providing a simple structure that can be manipulated and projected forward, thereby reducing the complexity of the computational processing.

An additional difficulty not addressed by prior art segmentation and identification systems relates to changes in illumination that may obscure image changes due to occupant motion. When computing the segmented image of an occupant, it is desirable to include and implement a processing technique that can model the illumination field and remove it from consideration.

Systems and methods that overcome many of the described limitations of the prior art have been disclosed in the related applications that are cross-referenced above. For example, the co-pending application “MOTION-BASED IMAGE SEGMENTOR FOR OCCUPANT TRACKING,” application Ser. No. 10/269,237, filed on Oct. 11, 2002, teaches a system and method using motion to define a template that can be matched to the segmented image, and which, in one embodiment, uses ellipses to model and represent a vehicle occupant. These ellipses may be processed by tracking subsystems to project the most likely location of the occupant based on a previous determination of position and motion. The ellipses, as projected by the tracking subsystems, may also be used to define a “region of interest,” image representing a subset area of the ambient image, that may be used for subsequent processing to reduce processing requirements.

An advantageous method that may be applied to the problem of segmenting images in the presence of motion employs the technique of optical flow computation. The inventive methods according to the related U.S. Patent applications cross-referenced above employ alternative segmentation methods that do not include optical flow computations. Further, in order to apply optical flow computations for detecting occupants in a vehicle, it is necessary to remove obscuring effects caused by variations in illumination fields when computing the segmented images. Therefore, a need exists for image segmentation systems and methods using optical flow techniques that discriminate true object motion from effects due to illumination fields. The present invention provides such an image segmentation system and method.

### SUMMARY

An image segmentation system and method are disclosed that generate a segmented image of a vehicle occupant or other target of interest based upon an ambient image, which includes the target and the environment that surrounds the target. The inventive method and apparatus further determines a bounding ellipse that is fitted to the segmented target image. The bounding ellipse may be used to project a future position of the target.

In one embodiment, an optical flow technique is used to compute both velocity fields and illumination fields within the ambient image. Including the explicit computation of the illumination fields dramatically improves motion estimation for the target image, thereby improving segmentation of the target image.

### DESCRIPTION OF THE DRAWINGS

FIG. 1 is a simplified block diagram of a system for capturing an ambient-image, processing the image, and providing a deployment decision to an airbag deployment system that may be adapted for use with the present inventive teachings.

FIG. 2 illustrates an exemplary image segmentation and processing system incorporated into an airbag decision and deployment system.

FIG. 3 illustrates an exemplary ambient image including a vehicle occupant, and also including an exemplary bounding ellipse fitted to the occupant image.

FIG. 4 is a schematic representation of a segmented image representing a vehicle occupant, having an exemplary bounding ellipse, and also illustrating shape parameters for the bounding ellipse.

FIG. 5 is a flowchart illustrating an exemplary method for computing a segmented image and ellipse shape parameters in accordance with the present disclosure.

FIG. 6 shows exemplary images comparing the standard gradient optical flow and the extended gradient optical flow techniques.

FIG. 7 illustrates exemplary results of computations according to the extended gradient optical flow technique of the present disclosure.

FIG. 8 shows an exemplary binary image that may be produced by a segnebtation system, in accordance with the present inventive techniques.

Like reference numbers and designations in the various drawings indicate like elements.

### DETAILED DESCRIPTION

Throughout this description, embodiments and variations are described for the purpose of illustrating uses and implementations of the inventive concept. The illustrative description should be understood as presenting examples of the inventive concept, rather than as limiting the scope of the concept as disclosed herein.

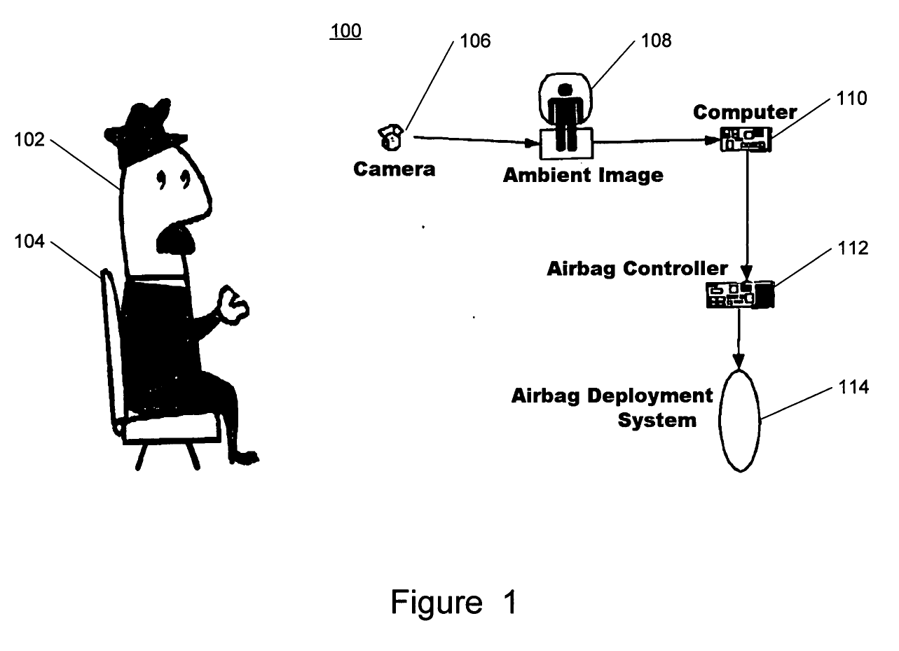

FIG. 1 is a simplified illustration of an airbag control system 100, adapted for use with the present inventive teachings. A vehicle occupant 102 may be seated on a seat 104 inside a vehicle (not shown). A video camera 106, or other sequential imaging sensor or similar device, produces a series of images that may include the occupant 102, or portions thereof, if an occupant is present. The images will also include a surrounding environment, such as interior parts of the vehicle, and may also include features due to objects outside the vehicle.

An ambient image 108 is output by the camera 106, and provided as input to a computer or computing device 110. In one embodiment of the inventive teachings, the ambient image 108 may comprise one frame of a sequence of video images output by the camera 106. The ambient image 108 is processed by the computer 110 according to the inventive teachings described in more detail hereinbelow. In one embodiment, after processing the ambient image 108, the computer 110 may provide information to an airbag controller 112 to control or modify activation of an airbag deployment system 114.

Teachings relating to airbag control systems, such as used in the system 100, are disclosed in more detail in the co-pending commonly assigned patent application “MOTION-BASED IMAGE SEGMENTOR FOR OCCUPANT TRACKING,” application Ser. No. 10/269,237, filed on Oct. 11, 2002, incorporated by reference herein, as though set forth in full, for its teachings regarding techniques for identifying a segmented image of a vehicle occupant within an ambient image. Novel methods for processing the ambient image 108 are disclosed herein, in accordance with the present inventive teachings.

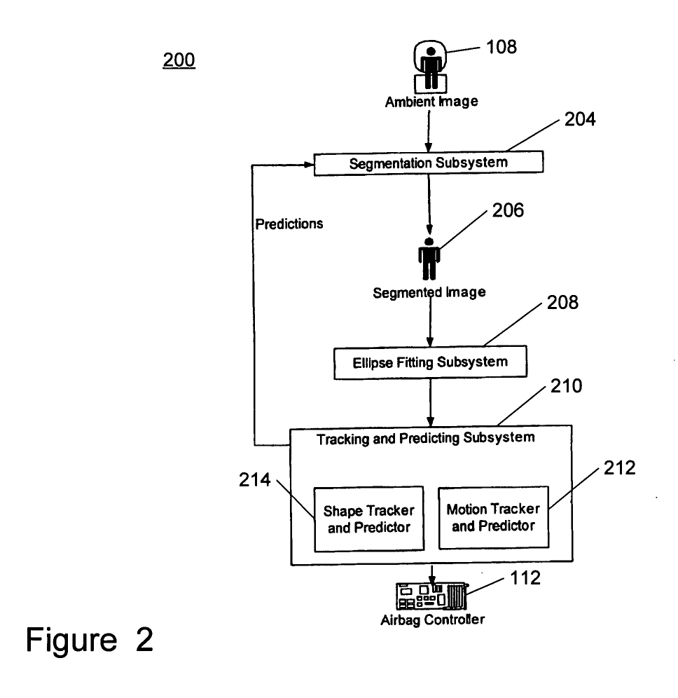

FIG. 2 is a flow diagram illustrating an embodiment of an image processing system 200 that may be used in conjunction with the airbag control system 100 and implemented, for example, within the computer 110 (FIG. 1). As shown in FIG. 2, the ambient image 108 is provided as input to a segmentation subsystem 204. The segmentation subsystem 204 performs computations, described in more detail hereinbelow, necessary for generating a segmented image 206. The segmented image 206 is based upon features present in the ambient image 108.

As shown in the embodiment of the image processing system 200 of FIG. 2, the segmented image 206 is further processed by an ellipse fitting subsystem 208. The ellipse fitting subsystem 208 computes a bounding ellipse (not shown) fitted to the segmented image 206, as described in more detail hereinbelow. In one embodiment, an output from the ellipse fitting subsystem 208 may be processed by a tracking and predicting subsystem 210. The tracking and predicting subsystem 210 may further include a motion tracker and predictor block 212, and a shape tracker and predictor block 214, as described in the above-incorporated U.S. patent application Ser. No. 10/269,237.

In one embodiment, the tracking and predicting subsystem 210 provides information to the airbag controller 112 (FIGS. 1 and 2) to control or modify an airbag deployment decision. In some embodiments, the tracking and predicting subsystem 210 may also input predictions, or projected information, to the segmentation subsystem 204. For example, the projected information may include a set of projected ellipse parameters based on the most recent bounding ellipse parameters (described in detail below) computed by the ellipse fitting subsystem 208. In one embodiment, the subsystem 210 uses the position and shape of the most recently computed bounding ellipse, and projects it to the current image frame time, using a state transition matrix. This is done by multiplying the most recent bounding ellipse parameters by a state transition matrix to produce new values predicted at a new time instance. The prediction process and the state transition matrix are disclosed in more detail in the above-incorporated U.S. patent application Ser. No. 10/269,237. The projected information, as input to the segmentation subsystem 204, may be employed in accordance with the present inventive teachings as described hereinbelow.

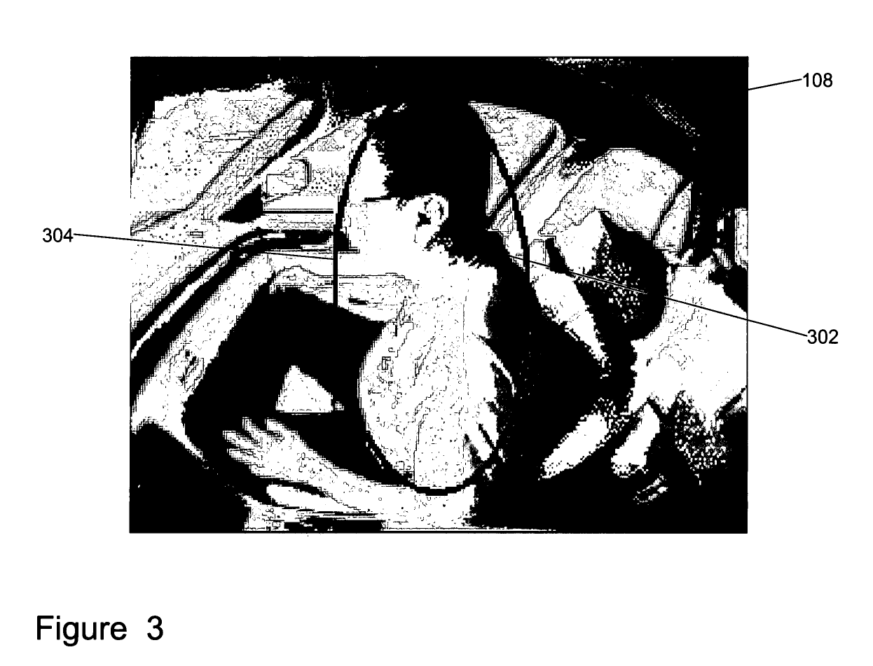

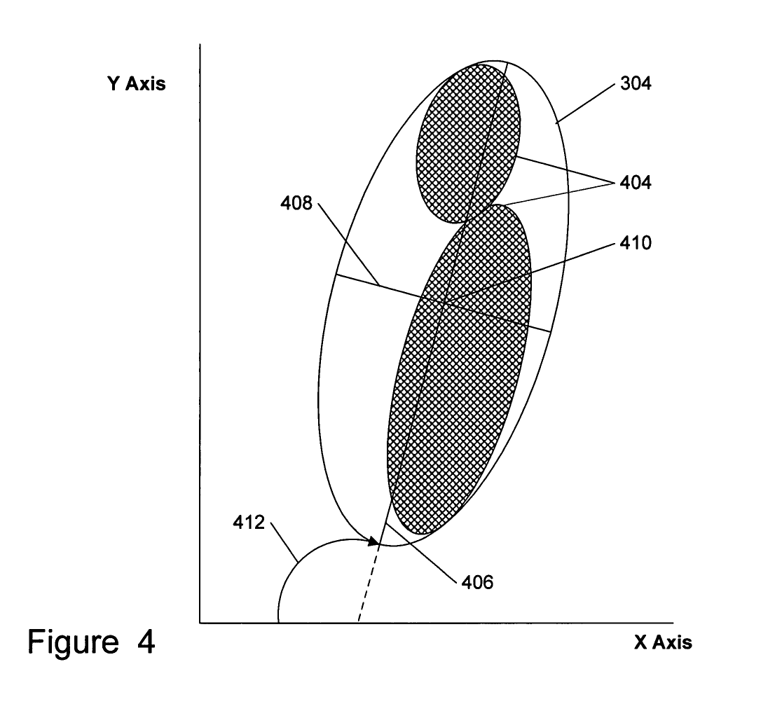

FIG. 3 illustrates an ambient image 108 including an occupant image 302, and also including an exemplary bounding ellipse 304 for the occupant image 302. FIG. 4 is a schematic representation of a vehicle occupant image 404 (shown in cross-hatched markings) and an exemplary bounding ellipse 304. The cross-hatched element 404 schematically represents a portion of an occupant image, such as the occupant image 302 of FIG. 3. The bounding ellipse 304 has the following ellipse shape parameters (also referred to as “ellipse parameters”): a major axis 406; a minor axis 408; a centroid 410; and a tilt angle 412. As described below in more detail, the ellipse parameters define, and may be used to compute, the location and shape of the bounding ellipse 304.

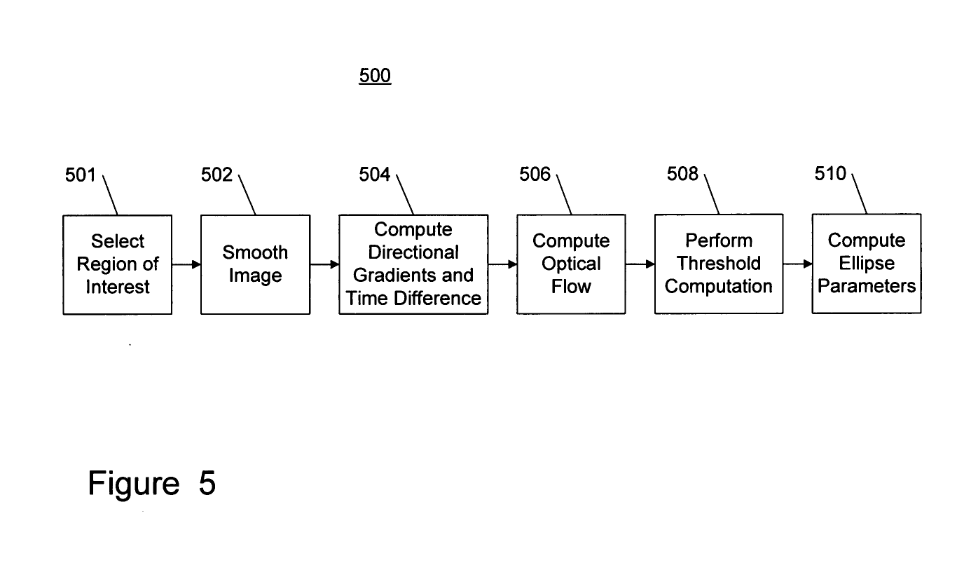

FIG. 5 is a flowchart illustrating an exemplary inventive method 500 for computing a segmented image and ellipse shape parameters from an ambient image, in accordance with the present teachings. In one embodiment, the STEPS 501 through 510, inclusive, and their related processing modules, may be incorporated in the segmentation subsystem 204 and the ellipse fitting subsystem 208 as shown in FIG. 2.

In one embodiment, a selected part or subset of the ambient image 108 (FIGS. 1 and 2) may be selected for processing instead of a larger portion or the entire ambient image. For example, if a region of interest of the image (or, equivalently, a “region of interest”) is determined, as described below with reference to the STEP 501, the region of interest image may be used instead of the entire ambient image (e.g., the image output by the camera 106) for the subsequent processing steps according to the method 500. When referring to the “ambient image” in reference to the STEPS 502 through 510 as described below, it should be understood that the term “ambient image” may refer to either a larger ambient image, the entire ambient image, or the selected subset or part of the larger ambient image.

At the STEP 501, an embodiment of the inventive method may invoke a region of interest module to determine a region of interest image. In one embodiment, the region of interest determination may be based on projected ellipse parameters received from the tracking and prediction subsystem 210 (FIG. 2). The region of interest determination may be used to select a subset of a larger ambient image (which may be the current ambient image 108 as output by the camera 106, or a prior ambient image that has been stored and retrieved) for further processing. As one example, the region of interest may be determined as a 25 rectangle that is oriented along the major axis (e.g., the major axis 406 of the bounding ellipse 304 of FIG. 4) of the projected bounding ellipse computed according to the projected ellipse parameters. The top of the rectangle may be located at a first selected number of pixels above the top of the bounding ellipse. The lower edge of the rectangle may be located at a second selected number of pixels below the midpoint of the bounding ellipse (i.e., above the bottom of the bounding ellipse). This is useful in ignoring pixels located near the bottom of the image. It is occasionally useful to ignore these areas of the image because these pixels tend to experience very little motion because an occupant tends to rotate about the hips which are fixed in the vehicle seat. The sides of the rectangle may be located at a third selected number of pixels beyond the ends of the minor axis (e.g., the minor axis 408 of the ellipse 304 of FIG. 4) of the bounding ellipse. The results of the region of interest calculation may be used in the subsequent processing steps of the method 500 in order to greatly reduce the processing requirements, and also in order to reduce the detrimental effects caused by extraneous motion, such as, for example, hands waving and objects moving outside a vehicle window. Other embodiments may employ a region of interest that is different, larger, or smaller than the region of interest described above.

In other embodiments, or when processing some ambient images within an embodiment, the region of interest determination of the STEP 501 may omitted. For example, at certain times, the projected ellipse parameters may not be available because prior images have not been received or computed, or for other reasons. If the STEP 501 is omitted, or is not executed, and a region of interest thereby is not determined, the subsequent steps of the 1 5 exemplary method 500 may be performed on a larger ambient image, such as may be received from the camera 106 of FIG. 1, rather than on a selected subset of the larger current ambient image. If the STEP 501 is executed, then a subset of the larger current ambient image is selected as the current ambient image, based on the specified region of interest.

In one embodiment, at STEP 502 of the inventive method 500, an image smoothing process is performed on the ambient image using an image smoothing module. For example, the smoothing process may comprise a 2-dimensional Gaussian filtering operation. Other smoothing processes and techniques may be implemented. The 2-dimensional Gaussian filtering operation and other smoothing operations are well known to persons skilled in the arts of image processing and mathematics, and therefore are not described in further detail herein. The image smoothing process is performed in order to reduce the detrimental effects of noise in the ambient image. The image smoothing process step 502 may be omitted in alternative embodiments, as for example, if noise reduction is not required. The method next proceeds to a STEP 504.

At STEP 504, directional gradient and time difference images are computed for the ambient image. In one embodiment, the directional gradients are computed according to the following equations:
Iₓ=Image(i, j)−Image(i−N, j)=I(i, j)−I(i−N, j); (1)
I_{y}=Image(i, j)−Image(i,j−N)=I(i, j)−I(i,j−N); (2)
Iₜ=Image₂(i, j)−Image₁(i, j); (3)
wherein Image(i, j) comprises the current ambient image brightness (or equivalently, luminosity, or signal amplitude) distribution as a function of the coordinates (i, j); Image₁(i, j) comprises the image brightness distribution for the ambient image immediately prior to the current ambient image; Image₂(i, j) comprises the brightness distribution for the current ambient image (represented without a subscript in the equations (1) and (2) above, Iₓ comprises the directional gradient in the x-direction; I_{y} comprises the directional gradient in the y-direction; Iₜ comprises the time difference distribution for difference of the current ambient image and the prior ambient image; and N comprises a positive integer equal to or greater than 1, representing the x or y displacement in the ambient image used to calculate the x or y directional gradient, respectively. The directional gradient computation finds areas of the image that are regions of rapidly changing image amplitude. These regions tend to comprise edges of two different objects, such as, for example, the occupant and the background. The time difference computation locates regions where significant changes occur between successive ambient images. The method next proceeds to a STEP 506.

At the STEP 506, an optical flow computation is performed in order to determine optical flow velocity fields (also referred to herein as “optical flow fields” or “velocity fields”) and illumination fields. The standard gradient optical flow methods assume image constancy, and are based on the following equation:

$$\frac{\partial f}{\partial t} + v \cdot grad ( f ( x , y , t ) ) = 0 ; \qquad ( 4 )$$

wherein f(x,y,t) comprises the luminosity or brightness distribution over a sequence of images, and wherein v comprises the velocity vector at each point in the image.

These standard gradient optical flow methods are unable to accommodate scenarios where the illumination fields are not constant. Therefore, the present teachings employ an extended gradient (also equivalently referred to herein as “illumination-enhanced”) optical flow technique based on the following equation:

$$\frac{\partial f}{\partial t} = - f ( x , y , t ) \cdot div ( v ) - v \cdot grad ( f ( x , y , t ) ) + ϕ ; \qquad ( 5 )$$

wherein ø represents the rate of creation of brightness at each pixel (i.e., the illumination change). If a rigid body object is assumed, wherein the motion lies in the imaging plane, then the term div(v) is zero. This assumption is adopted for the exemplary computations described herein. The extended gradient method is described in more detail in the following reference, S. Negahdaripour, “Revised definition of optical flow: Integration of radiometric and geometric cues for dynamic scene analysis”, IEEE Trans. on Pattern Analysis and Machine Intelligence, vol. 20 no. 9, pp. 961-979, September 1998. This reference is referred to herein as the “Negahdaripour” reference, and it is hereby fully incorporated by reference herein, as though set forth in full, for its teachings on optical flow techniques and computation methods.

The term ø provides the constraints on the illumination variations in the image. There are two types of illumination variation that must be considered: (i) variations in illumination caused by changes in reflectance or diffuse shadowing (modeled as a multiplicative factor), and (ii) variation in illumination caused by illumination highlighting (modeled as an additive factor). In accordance with the above-incorporated Neghadaripour reference, the term ø can be expressed using the following equation:

$$ϕ = f \cdot \frac{\partial m}{\partial t} + \frac{\partial c}{\partial t} ; \qquad ( 6 )$$

wherein the term

$$\frac{\partial m}{\partial t}$$

corresponds to the change in reflectance, and wherein the term

$$\frac{\partial c}{\partial t}$$

corresponds to the illumination highlighting.

Also, in accordance with the Neghadaripour reference, optical flow velocity fields (or equivalently, the optical flow field image) and illumination fields (or equivalently, the illumination field image) may be computed by solving the following least squares problem:

$${\sum }_{W}^{} [ \begin{matrix}{I}_{x}^{2} & {I}_{x} {I}_{y} & - {I}_{x} I & - {I}_{x} \\ {I}_{x} {I}_{y} & {I}_{y}^{2} & - {I}_{y} I & - {I}_{y} \\ - {I}_{x} I & - {I}_{y} I & {I}^{2} & I \\ - {I}_{x} & - {I}_{y} & I & 1\end{matrix} ] \cdot [ \begin{matrix}δ x \\ δ y \\ δ m \\ δ c\end{matrix} ] = {\sum }_{W}^{} [ \begin{matrix}- {I}_{x} {I}_{t} \\ - {I}_{y} {I}_{t} \\ {I}_{t} I \\ {I}_{t}\end{matrix} ] , \qquad ( 7 )$$

wherein the terms δx and δy comprise the velocity estimates for the pixel (x,y), the expression δm=m−1 comprises the variation or difference value for the multiplicative illumination field, the term δc comprises the variation value for the additive illumination field, W comprises a local window of N by N pixels (where N is a positive integer greater than 3) centered around each pixel in the ambient image I, and I, Iₓ, I_{y} and Iₜ are as defined hereinabove with reference to Equations 1-3 (inclusive). The velocity variables δx and δy may also represent the U (horizontal) and the V (vertical) components, respectively, of the optical flow velocity field v.

Those skilled in the mathematics art shall recognize that equation (7) above may be solved for the velocity variables δx, δy, and the illumination variables δm and δc, by numerical computation methods based on the well known least squares technique, and as described in detail in the Negahdaripour reference.

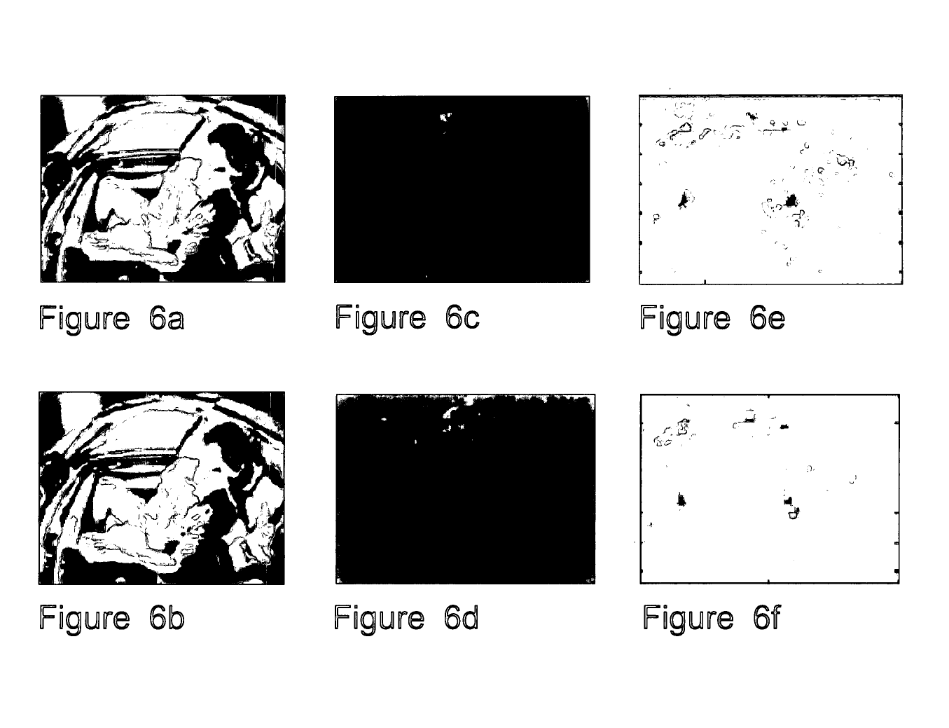

FIG. 6 shows a comparison of standard gradient optical computation results and the extended gradient optical flow computation results, illustrating the advantage of the extended gradient optical flow method over the standard gradient optical flow method. The standard gradient optical flow computation may be performed by setting the variables δm=0 and δc=0 in equation (7) above, and solving only for the δx and δy variables.

FIG. 6 includes exemplary gray-scale representations of the δx and δy variable 20 values. More specifically, FIG. 6a shows a first ambient image; FIG. 6b shows a second ambient image; FIG. 6c shows the U-component for the standard gradient optical flow computation; FIG. 6d shows the U-component for the extended (illumination-enhanced) gradient optical flow computation; FIG. 6e shows the V-component for the standard gradient optical flow computation; and FIG. 6f shows the V-component for the extended gradient optical flow computation. Inspection of the images shown in FIGS. 6a-6f indicates that implementation of the extended gradient optical flow computation method dramatically improves the motion estimation for the moving target, comprising the upper portions of the occupant image. For example, as shown in FIG. 6e, there is significantly more erroneous motion caused by illumination changes on the occupant's legs, as compared to FIG. 6f, where these illumination effects are correctly modeled, and only the true motion is left.

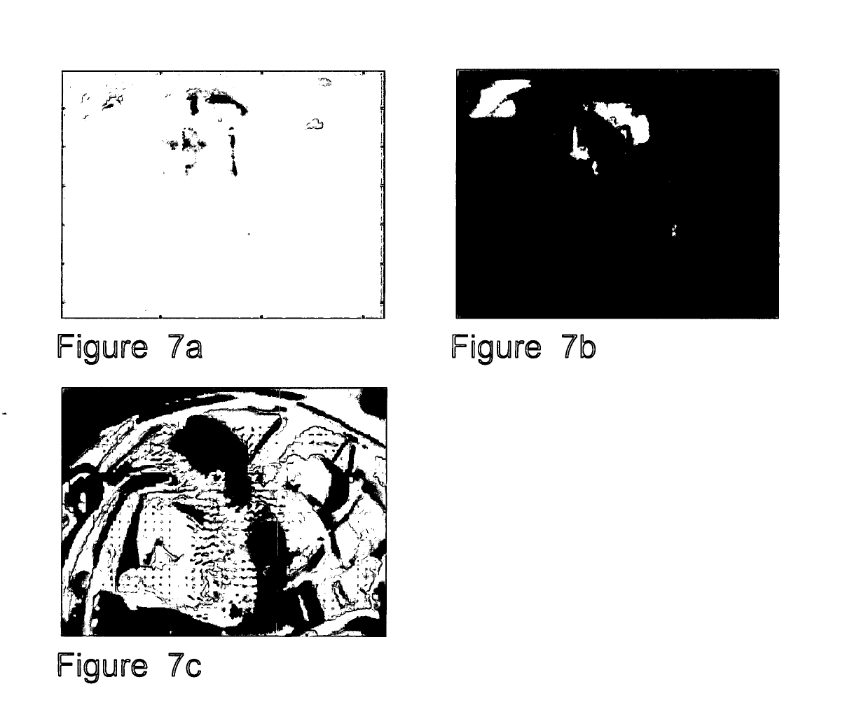

FIG. 7 presents additional exemplary results for the extended gradient optical flow computation performed at the STEP 506 of FIG. 5. The image of FIG. 7a is a gray-scale representation of the U-component of the optical flow field. The image shown in FIG. 7b comprises a gray-scale representation of V-component. The image shown in FIG. 7c comprises a representation of the optical flow vector amplitudes superimposed on an ambient image including an occupant in motion.

Referring again to the FIG. 5, the optical flow field results output by the STEP 506 are input to a STEP 508, wherein an adaptive threshold motion image (also equivalently referred to as the “adaptive threshold image”) is generated. This STEP determines the pixels in the current image that are to be used to compute the bounding ellipse. In one embodiment, the STEP first computes a histogram of the optical flow amplitude values. Next, the cumulative distribution function (CDF) is computed from the histogram. The CDF is then thresholded at a fixed percentage of the pixels. In the thresholding process, pixels above a selected threshold are reset to an amplitude of 1, and pixels below the threshold are reset to an amplitude of 0, thereby producing a binary image representative of the segmented image of the target. As an example, the threshold level may be set at a level selected so that the amplitude-1 part of the binary image includes 65% of the pixels within the ambient image. Threshold levels other than 65% may be used as required to obtain a desired degree of discrimination between the target and the surrounding parts of the ambient image. The techniques of computing a histogram and a CDF are well known to persons skilled in the mathematics arts. Further, a method for computing an adaptive threshold, in the context of use within an image segmentation system, is disclosed in more detail in the above-incorporated co-pending U.S. Patent application “IMAGE SEGMENTATION SYSTEM AND METHOD,” application Ser. No. 10/023,787, filed on Dec. 17, 2001. The outputs of the adaptive threshold image computations STEP 508 are input to a STEP 510.

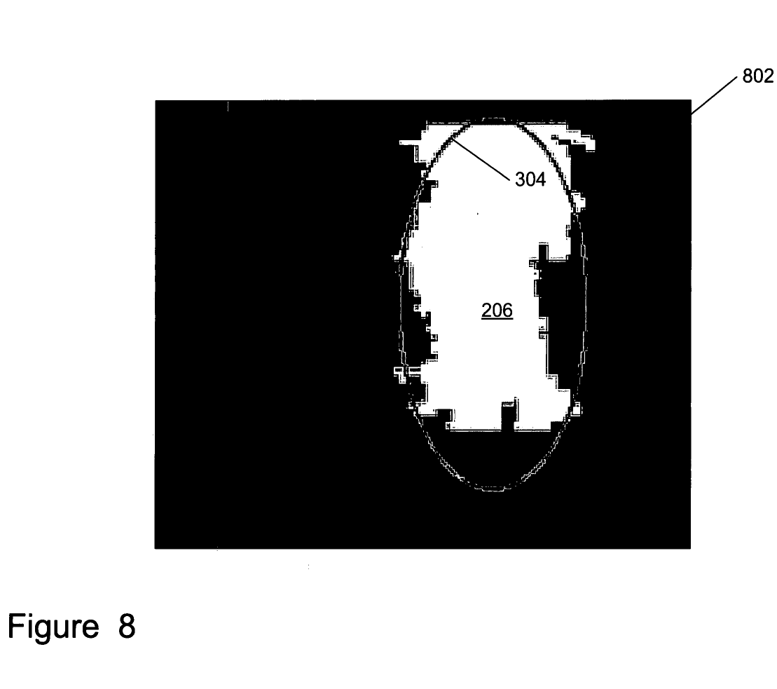

At the STEP 510, one embodiment of the inventive method may invoke an ellipse fitting module in order to compute the bounding ellipse parameters corresponding to the binary image output by the computation performed by the STEP 508. In other embodiments, shapes other than ellipses may be used to model the segmented image. FIG. 8 shows an exemplary binary image 802 such as may be input to the STEP 510. Within the binary image 802 is a segmented image 206 and an exemplary bounding ellipse 304. In one embodiment, the bounding ellipse 304 may be computed according to a moments-based ellipse fit as described below.

The bounding ellipse shape parameters may be determined by computing the central moments of a segmented, N×M binary image I(i, j), such as is represented by the binary image 802 of FIG. 8. The second order central moments are computed according to the following equations (8), (9) and (10):

$$\begin{matrix}{\sum }_{xx}^{} = \frac{1}{{m}_{00}} {\sum }_{i = 1}^{N} {\sum }_{j = 1}^{M} I ( i , j ) \cdot {( x - {μ}_{x} )}^{2} , & ( 8 ) \\ {\sum }_{xy}^{} = \frac{1}{{m}_{00}} {\sum }_{i = 1}^{N} {\sum }_{j = 1}^{M} I ( i , j ) \cdot ( x - {μ}_{x} ) ( y - {μ}_{y} ) , & ( 9 ) \\ {\sum }_{yy}^{} = \frac{1}{{m}_{00}} {\sum }_{i = 1}^{N} {\sum }_{j = 1}^{M} I ( i , j ) \cdot {( y - {μ}_{y} )}^{2} . & ( 10 )\end{matrix}$$

The lower order moments, m₀₀, μₓ and μₓ, above are computed according to the following equations (11), (12) and (13):

$$\begin{matrix}{m}_{00} = {\sum }_{i = 1}^{N} {\sum }_{j = 1}^{M} I ( i , j ) , & ( 11 ) \\ {μ}_{x} = \frac{1}{{m}_{00}} {\sum }_{i = 1}^{N} {\sum }_{j = 1}^{M} I ( i , j ) \cdot x , & ( 12 ) \\ {μ}_{y} = \frac{1}{{m}_{00}} {\sum }_{i = 1}^{N} {\sum }_{j = 1}^{M} I ( i , j ) \cdot y , & ( 13 )\end{matrix}$$

Based on the equations (8) through (13), inclusive, the bounding ellipse parameters are defined by the equations (14) through (18), inclusive, below:

$$\begin{matrix}{centroid}_{x} = {μ}_{x} , & ( 14 ) \\ {centroid}_{y} = {μ}_{y} , & ( 15 ) \\ \begin{matrix}{L}_{major} = \frac{1}{2} \cdot ( {\sum }_{xx}^{} + {\sum }_{yy}^{} ) + \\ \frac{1}{2} \cdot \sqrt{{\sum }_{yy}^{2} + {\sum }_{xx}^{2} - 2 \cdot {\sum }_{xx}^{} \cdot {\sum }_{yy}^{} + 4 \cdot {\sum }_{xy}^{2} }\end{matrix} , & ( 16 ) \\ \begin{matrix}{L}_{minor} = \frac{1}{2} \cdot ( {\sum }_{xx}^{} + {\sum }_{yy}^{} ) - \\ \frac{1}{2} \cdot \sqrt{{\sum }_{yy}^{2} + {\sum }_{xx}^{2} - 2 \cdot {\sum }_{xx}^{} \cdot {\sum }_{yy}^{} + 4 \cdot {\sum }_{xy}^{2} }\end{matrix} , & ( 17 ) \\ Slope = ArcTan 2 ( {L}_{major} - {\sum }_{xx}^{} , {\sum }_{xy} ) . & ( 18 )\end{matrix}$$

Referring again to FIG. 4 and to the equations (14) through (18), above, the following equivalencies are defined: the x-coordinate for the centroid 410 comprises the centroidx, the y-coordinate for the centroid 410 comprises the centroidy, the major axis 406 comprises Lmajor the minor axis 408 comprises Lminor, and the tilt angle 412 comprises the angle Slope.

Referring again to FIG. 5, upon completion of the STEP 510, a segmented image representing a vehicle occupant or other target is obtained, and the ellipse parameters defining a bounding ellipse for the segmented image are computed. In one embodiment of the inventive concept, STEPS 502 through 510 of the method 500 may be executed by respective processing modules in a computer such as the computer 110 of FIG. 1. In one embodiment, the STEPS 502 through 508 may be incorporated in a segmentation subsystem 204 as illustrated in FIG. 2, and the STEP 510 may be incorporated in the ellipse fitting subsystem 208. The bounding ellipse parameters computed during the STEP 510 may be provided as input to a tracking and predicting subsystem, such as the subsystem 210, for further processing as described hereinabove, and as described in the co-pending above-incorporated U.S. Patents and applications (e.g., the U.S. patent application Ser. No. 10/269,237).

Those of ordinary skill in the communications and computer arts shall also recognize that computer readable medium which tangibly embodies the method steps of any of the embodiments herein may be used in accordance with the present teachings. For example, the method steps described above with reference to FIGS. 1, 2, and 5 may be embodied as a series of computer executable instructions stored on a computer readable medium. Such a medium may include, without limitation, RAM, ROM, EPROM, EEPROM, floppy disk, hard disk, CD-ROM, etc. The disclosure also contemplates the method steps of any of the foregoing embodiments synthesized as digital logic in an integrated circuit, such as a Field Programmable Gate Array, or Programmable Logic Array, or other integrated circuits that can be fabricated or modified to embody computer program instructions.

A number of embodiments of the present inventive concept have been described. Nevertheless, it will be understood that various modifications may be made without departing from the scope of the inventive teachings. For example, the methods of the present inventive concept can be executed in software or hardware, or a combination of hardware and software embodiments. As another example, it should be understood that the functions described as being part of one module may in general be performed equivalently in another module. As yet another example, steps or acts shown or described in a particular sequence may generally be performed in a different order, except for those embodiments described in a claim that include a specified order for the steps.

Accordingly, it is to be understood that the inventive concept is not to be limited by the specific illustrated embodiments, but only by the scope of the appended claims. The description may provide examples of similar features as are recited in the claims, but it should not be assumed that such similar features are identical to those in the claims unless such identity is essential to comprehend the scope of the claim. In some instances the intended distinction between claim features and description features is underscored by using slightly different terminology.

1. A method for isolating a current segmented image from a current ambient image, comprising the steps of:
a) computing a directional gradient image for the current ambient image;
b) computing a time difference image, wherein the time difference image comprises a difference between the current ambient image and a prior ambient image;
c) computing an optical flow field image and an illumination field image, responsive to the directional gradient image, the time difference image, and the current ambient image; and
d) performing an adaptive threshold computation on the optical flow field image thereby generating a binary image, wherein the current segmented image corresponds to and is associated with at least part of the binary image.

2. The method of claim 1, further comprising the step of computing ellipse parameters for a bounding ellipse corresponding to and associated with at least part of the binary image.

3. The method of claim 1, wherein the current ambient image is a subset of a larger current ambient image.

4. The method of claim 3, further comprising the steps of:
a) determining a region of interest within the larger current ambient image; and
b) selecting the subset of the larger current ambient image responsive to the region of interest.

5. The method of claim 4, further comprising the steps of:
a) receiving projected ellipse parameters, wherein the projected ellipse parameters are responsive to at least one prior segmented image;
b) computing a projected bounding ellipse corresponding to and associated with the projected ellipse parameters; and
c) determining the region of interest responsive to the projected bounding ellipse.

6. The method of claim 1, wherein the step of computing the optical flow field image includes a summation procedure over a window W centered around each pixel in the current ambient image, and wherein the window W is a region encompassing at least 3 by 3 pixels.

7. The method of claim 1, wherein the optical flow field image includes velocity components for at least one coordinate direction.

8. The method of claim 1, wherein the illumination field image includes at least one of the following: a) a multiplicative illumination field image, and b) an additive illumination field image.

9. The method of claim 1, wherein the step (d) of performing the adaptive threshold computation generating a binary image further comprises the steps of:
i) computing a histogram function, wherein the histogram function corresponds to and is associated with at least part of the optical flow field image;
ii) computing a Cumulative Distribution Function (CDF) based on the histogram function;
iii) setting a threshold level for the CDF; and
iv) generating the binary image responsive to the threshold level.

10. The method according to claim 9, further comprising the steps of:
v) computing central moments and lower order moments relating to the binary image; and
vi) computing bounding ellipse parameters corresponding to and associated with the central moments and the lower order moments.

11. The method according to claim 1, further comprising the step of smoothing the current ambient image.

12. A segmentation system for isolating a current segmented image from a current ambient image, comprising:
a) a camera, wherein the camera outputs a the current ambient image and a prior ambient image, and wherein the current ambient image includes the current segmented image;
b) a directional gradient and time difference module, wherein the directional gradient and time difference module generates a directional gradient image and a time difference image based on the current ambient image and the prior ambient image;
c) an optical flow module, wherein the optical flow module calculates and outputs an optical flow field image and an illumination field image; and
d) an adaptive threshold module, wherein the adaptive threshold module generates a binary image, and wherein the current segmented image corresponds to and is associated with at least part of the binary image.

13. The segmentation system of claim 12, further comprising an ellipse fitting module wherein the ellipse fitting module computes bounding ellipse parameters corresponding to and associated with, at least part of the binary image.

14. The segmentation system of claim 12, wherein the current ambient image is a subset of a larger current ambient image.

15. The segmentation system of claim 14, further comprising a region of interest module, wherein the region of interest module determines a region of interest image, and wherein the subset of the larger current ambient image is generated responsive to the region of interest image.

16. The segmentation system of claim 12, wherein the illumination field image includes at least one of the following: a) a multiplicative illumination field, and b) an additive illumination field.

17. The segmentation system of claim 12, further comprising an image smoothing module, wherein the image smoothing module smoothes the current ambient image to reduce effects of noise present in the current ambient image.

18. A segmentation system for isolating a current segmented image from a current ambient image, comprising:
a) means for computing a directional gradient image for the current ambient image;
b) means for computing a time difference image, wherein the time difference image comprises a difference between the current ambient image and a prior ambient image;
c) means for computing an optical flow field image and an illumination field image, responsive to the directional gradient image, the time difference image, and the current ambient image; and
a) means for performing an adaptive threshold computation on the optical flow field image thereby generating a binary image, wherein the current segmented image corresponds to and is associated with at least part of the binary image.

19. A computer program, executable on a general purpose computer, comprising:
a) a first set of instructions for computing a directional gradient image for the current ambient image;
b) a second set of instructions for computing a time difference image, wherein the time difference image comprises a difference between the current ambient image and a prior ambient image;
c) a third set of instructions for computing an optical flow field image and an illumination field image, responsive to the directional gradient image, the time difference image, and the current ambient image; and
d) a fourth set of instructions for performing an adaptive threshold computation on the optical flow field image thereby generating a binary image, wherein the current segmented image corresponds to and is associated with at least part of the binary image.
